(19) United States
(12) Patent Application Publication
(10) Pub. No.: US 2002/0076032 A1
(43) Pub. Date: Jun. 20, 2002

(54) On-hold information service with caller-controlled personalized menu

(75) Inventors: Herman Rodriguez, Austin, TX (US); Newton James Smith JR., Austin, TX (US); Clifford Jay Spinac, Austin, TX (US); Maria Azua Himmel, Yorktown Heights, NY (US)

Correspondence Address: Duke W. Yee, Carstens Yee & Cahoon LLP, P O Box 802334, Dallas, TX, 75380, US

(73) Assignee: INTERNATIONAL BUSINESS MACHINES CORPORATION, ARMONK, NY (US)

(21) Appl. No.: 09/737,423

(22) Filed: Dec. 15, 2000

(51) Int. Cl. H04M 3/00; H04M 5/00

(52) U.S. Cl. 379/266.01

(57) ABSTRACT

A party who makes a telephone call (a “calling party”) sets up a “personalized” menu identifying a set of information options from which he or she desires to select when placed on-hold in a telephone system. The user's personal preferences are then saved. When the party later makes a call to a telephone system and is placed on-hold, the telephone system accesses the user's personalized menu and offers the one or more information options as defined in the menu. In an illustrative embodiment, the personalized menu options are voiced over the telephone line and the calling party then makes selections using keypad (i.e. DTMF signaling) or voice input. A response may be interrupted to make another menu selection, or to repeat the current response. If the response being played has not completed when the called party answers, that response is suspended and may be completed when the caller is placed back on hold or the call is completed.

### BACKGROUND OF THE INVENTION

1. Technical Field

The present invention relates generally to telephone call on-hold information services and, in particular to techniques for enabling a caller to personalize a menu of information services that are made available when the caller is put on-hold in a telephone system.

2. Description of the Related Art

It is well-known in the prior art to provide information to a caller who is placed on-hold in a telephone system. Typical call-on-hold systems provide music or other audio messages to the caller while he or she waits for the called party to answer the call. These types of systems are in widespread use in telephone call or contact centers. A “call center” is an organization of people, telecommunications equipment and management Software that efficiently handle telephone-based customer contact. A representative call center on-hold information service is described in U.S. Pat. No. 6,014,439 to Walker et al. This patent teaches a system for entertaining a caller placed in a queue of a call center that allows the caller to access a plurality of entertainment options while on-hold. The entertainment options permit the caller who is on-hold to place a call to a third party, or to access one or more premium entertainment services. In this system, a private branch exchange/automatic call distributor (PBX/ACD) receives the calls destined for the call center and queues the calls when an appropriate call handling agent is not available. An interactive voice response unit (IVR) prompts a caller for specific information and forwards the collected information to the PBX/ACD. The IVR provides the caller with a menu of available information options, which can be accessed by the caller. After a selection is made, the PBX/ACD establishes a connection between the caller and the selected entertainment service.

The prior art provides other examples of telephone on-hold information services outside of the call center environment. Representative patents includes U.S. Pat. Nos. 5,875,231 and 5,946,378 to Farfan et al. These patents describe an on-hold telephone service that allows a subscriber to place a call on-hold and to make one or more information services available to the calling party. The on-hold service can be implemented on a central office switch or on an enhanced services platform connected to the switch. The on-hold service is accessed by the subscriber to the service through a transfer function that causes the call to be maintained by the onhold service. The party that is placed on-hold by the subscriber (i.e. the called party) can then interactively acquire the various types of information available from the service, e.g., news, weather, stock market information, and the like. The subscriber to the service can send a message to the calling party to cause the calling party to selectively reconnect to the subscriber upon receipt of the message or, later, when the calling party is ready to do so. Other “on-hold” telephone systems are described in U.S. Pat. Nos. 5,444,774 and 5,920,616.

While “on-hold” systems such as described above are useful, the calling party has only limited control over the content he or she may select. That content is usually predetermined by the system provider. As a consequence, the calling party is often forced to listen to advertising or other informational messages that are likely to be of little interest to the user, who, in effect, is held hostage on the telephone line waiting for the called party. Systems like those disclosed in the '439 patent to Walker et al. provide somewhat more flexibility in that they allow the calling party more choices, however, few callers will want to make a third party call or will want to pay for premium entertainment services as is contemplated thereby.

The present invention addresses this deficiency in known on-hold information services.

### BRIEF SUMMARY OF THE INVENTION

A party who makes a telephone call (a “calling party”) sets up a “personalized” menu identifying a set of information options from which he or she desires to select when placed on-hold in a telephone system. The user's personal preferences are then saved. When the party later makes a call to a telephone system and is placed on-hold, the telephone system accesses the user's personalized menu and offers the one or more information options as defined in the menu. In an illustrative embodiment, the personalized menu options are voiced over the telephone line and the calling party then makes selections using keypad (i.e. DTMF signaling) or voice input. A response may be interrupted to make another menu selection, or to repeat the current response. If the response being played has not completed when the called party answers, that response is suspended and may be completed when the caller is placed back on-hold or the call is completed.

According to a further technical advantage of the invention, the particular options set forth in the calling party's menu may be reordered or prioritized from time-to-time depending on selections made by the calling party during prior “on-hold” sessions. This creates an “active” menu that more accurately reflects the calling party's preferences as the on-hold system is utilized. In a representative embodiment, more frequently selected items in the menu are played before less frequently selected items. The foregoing has outlined some of the more pertinent objects and features of the present invention. These objects and features should be construed to be merely illustrative of some of the more prominent features and applications of the invention. Many other beneficial results can be attained by applying the disclosed invention in a different manner of modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference should be made to the following Detailed Description taken in connection with the accompanying drawings in which:

For a more complete understanding of the present invention and the advantages thereof, reference should be made to the following Detailed Description taken in connection with the accompanying drawings in which:

FIG. 1 is a block diagram of the basic architecture of a telephone call center in which the present invention may be implemented;

FIG. 2 is a flowchart illustrating a preferred technique by which a user registers a personalized on-hold information service menu;

FIG. 3 is a representative web page at which a user may register his or her information option preferences to create a personalized active menu for use in the on-hold information service; FIG. 4 is a flowchart illustrating the on-hold information service offering;

FIG. 5 is a flowchart illustrating a menu adjustment routine of the present invention;

FIG. 6 is a flowchart illustrating a technique for generating a personalized menu as a function of a user profile or other identifying data.

### DETAILED DESCRIPTION OF THE PREFERRED EMBODIMENT

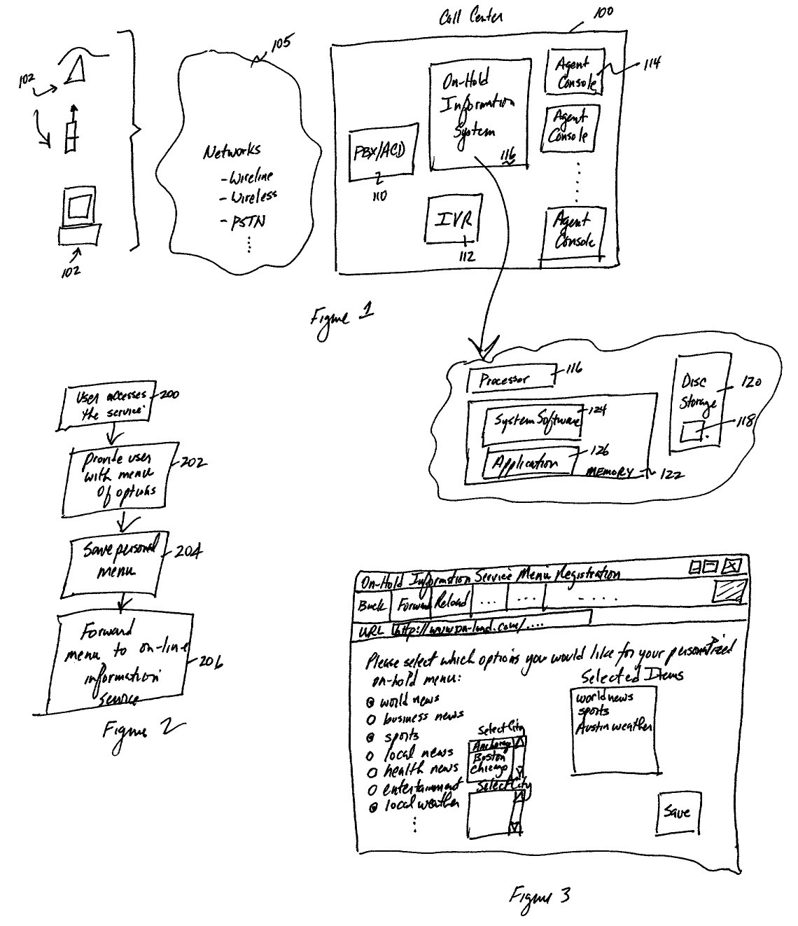

FIG. 1 is an illustrative network call or contact center environment in which the present invention may be implemented. In this environment, one or more callers at station sets 102 are waiting in a queue of a call center. A station set may be embodied as a conventional wireline telephone, a wireless phone, a personal computer or other pervasive computing device configured with appropriate telephony software and Internet connectivity, or the like. A call is routed via the telephone =network 105 to the call center 100. The call center 100 may include a PBX switch 110 with automatic call distribution capability. The PBX 110 may have an interactive voice response unit (IVR) 112 associated therewith. The PBX 110 and IVR 112 are well-known in the telephony art. The PBX is a switching system designed to receive telephone calls destined for call center 100 and to queue those calls when a call handling agent is not available. The IVR 112 is a voice information system that provides call prompting and DTMF tone and voice command detection, among other conventional functionality. Call handling agents at the attendant consoles 114 handle the calls following transfer from the hold queues.

The call center also includes an on-hold information system 116 comprising processor 118, disk storage 120, system memory 122, system software 124, and application software 126, among other conventional computer resources. According to the present invention, the onhold information system 116 provides a calling party with a personalized active menu 118 of information options that may be selected by the calling party when the party is placed on-hold by the call center 100. Unlike the prior art, a menu 118 preferably is defined by the calling party (as opposed to the system operator, a service provider, the called party, or the like), and this menu may be modified from time-to-time as the calling party uses the on-hold information system 116 and associated service offering. Although the on-hold information system 116 is illustrated as a standalone portion of the telephone call center 100, this is not a requirement of the present invention. One of ordinary skill in the art will appreciate that the inventive functionality may be built into the PBX, the IVR, or other apparatus or devices that comprise the call center. Moreover, the invention is not limited to use within a telephone call center environment; rather, the inventive caller-controlled menu functionality may be implemented within any on-hold information service regardless of the telephony environment. The call center environment of FIG. 1 is merely illustrative.

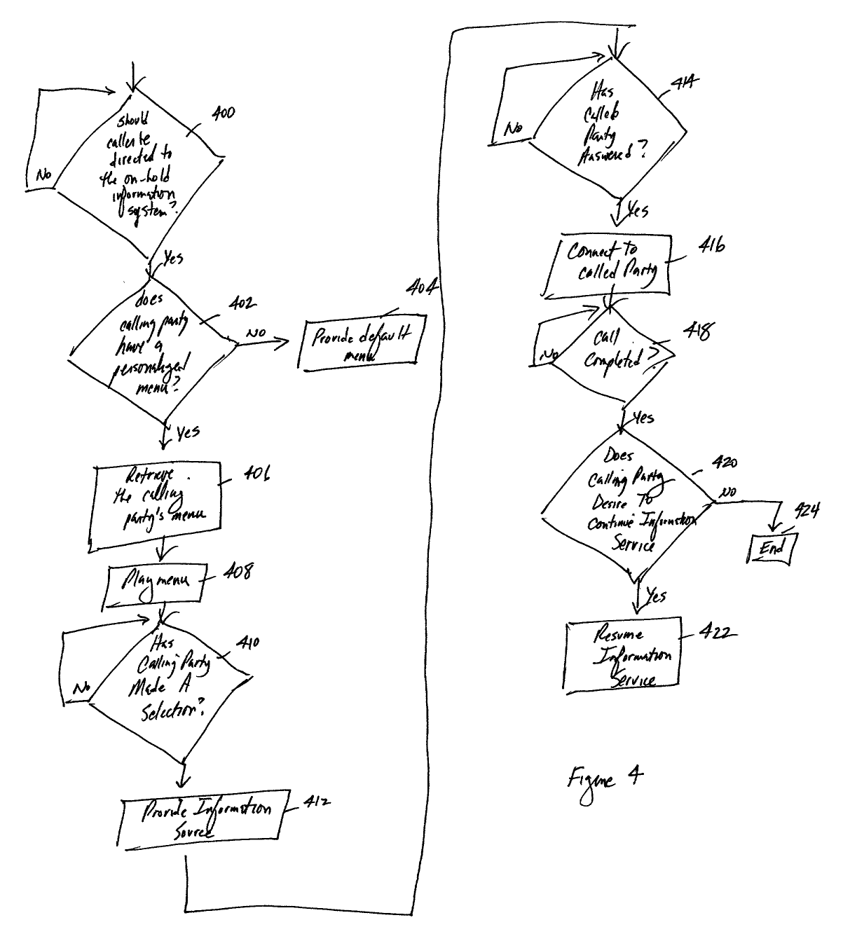

FIG. 2 is a flowchart of one illustrative method for registering a user to the on-hold information system. As used herein, a “user” or subscriber represents a calling party, i.e. a person that uses a station set to access the telephone call center (or other environment) in which the inventive on-hold information service is provisioned. Typically, the registration (or “subscription”) process is carried out off-line, i.e. before the user accesses the telephone call center and is placed within an on-hold queue. The routine begins at step 200 with the user accessing the information service to register his or her initial preferences for the onhold active menu. One convenient technique is for the user to access a web page supported on a web server. An illustrative web page 300 is shown in FIG. 3. At step 202, the user is provided with a menu describing the various information options that may be selected. The web page 300 in FIG. 3 illustrates various options including, for example: world news, business news, sports, local news, health news, entertainment, local weather, and the like. Each option has an associated radio button that may be selected. Some options, e.g., local news or weather, have an associated listbox that may be selected so that the user may select a particular city. One of ordinary skill will appreciate that any type of convenient user interface dialog may be used to enable the user to select a set of options and thus personalize his or her “on-hold” menu. In this example, the user has defined a personalized menu comprising world news, sports, and Austin weather. At step 204, the user saves the personalized menu, e.g., by selecting a SAVE button in the dialog. The personalized menu is then saved or stored within the on-line information system and service at step 206 to complete the process.

The personalized menu may be built or defined by the user in any other convenient manner. Thus, for example, a calling party may become a subscriber to the on-hold information service by registering over the telephone. Alternatively, the user may define his or her personalized menu manually and forward the menu selections to the service provider. Generalizing, a given menu option is composed of a static prompt and a dynamic response. For example, the static prompt may be “Press 1 for my portfolio quotes” while the dynamic response would be the calling party's current portfolio quotes. The on-hold information system has access to the information sources that are identified in the set of menu options that may be selected by the user. These sources may or may not comprise part of the on-hold information system.

FIG. 4 illustrates the operation of the on-hold information system. The routine begins at step 400 to test whether a calling party is to be directed to the onhold information system. Typically, a calling party is forwarded to the on-hold information system whenever the incoming call is placed in a hold queue (in the call center embodiment), although this is not a requirement of the invention. When the outcome of the test at step 400 indicates that the calling party is to be directed to the on-hold information system, the routine continues at step 402 to determine whether the calling party has a personalized menu. If the outcome of the test at step 402 is negative, the routine continues at step 404 to provide the user with a default menu of on-hold information options. This set of information options may be “intelligent” in the sense that the list of menu options is tailored to the user as a function of the user's originating telephone number. This functionality may be provided by analyzing the caller's originating telephone number using conventional caller ID techniques. The default menu provided in step 404 thus may include options (e.g., local weather, locale-based advertising, etc.) that may be relevant to the calling party given that the call originates from a given locality.

Rather than providing the default menu, the on-hold information system may default to a registration script to enable an unregistered or first-time caller to register a personalized menu as he or she is waiting for the given call to be completed. In particular, once the calling party is placed on-hold, he or she may be invited to register for the service. If the party desires to create a personalized menu, he or she is prompted to select a set of information options which then become the user's personalized menu for the current call and, optionally, future calls that are placed on-hold within the call center.

If the outcome of the test at step 402 indicates that the calling party has previously stored a personalized menu, the routine continues at step 406 to retrieve the calling party's menu that was previously stored within the system. At step 408, the personalized menu is played to the calling party. A test is then performed at step 410 to determine whether the calling party has made a selection. If not, the routine cycles. If, however, the calling party has made a selection, the routine continues at step 412 to provide the information option. Typically, the option is provided as a voiceover on the telephone line. The voiceover may be a live radio broadcast or other information service that was preselected by the calling party as indicated within the party's personalized menu. At step 414, a test is performed to determine whether the called party has answered. If not, the routine cycles. When the outcome of the test at step 414 indicates the called party has answered, the calling party is connected to the called party (e.g., a call handling agent). This is step 416. A test is then performed at step 418 to determine whether the call has been completed. If not, the routine cycles. If the outcome of the test at step 418 is positive, a test is performed at step 420 to determine if the calling party desires to continue with the information service. This test may be evaluated by providing a voice prompt to the calling party. The voice prompts may be provided, for example, using the IVR or some other voice prompting device. If the outcome of the test at step 420 is positive, the routine continues at step 422 to resume the information service, preferably at the point when the service offering was interrupted when the calling party was connected to the called party. If, however, the calling party does not wish to return to the information service, the routine terminates at step 424. This completes the processing.

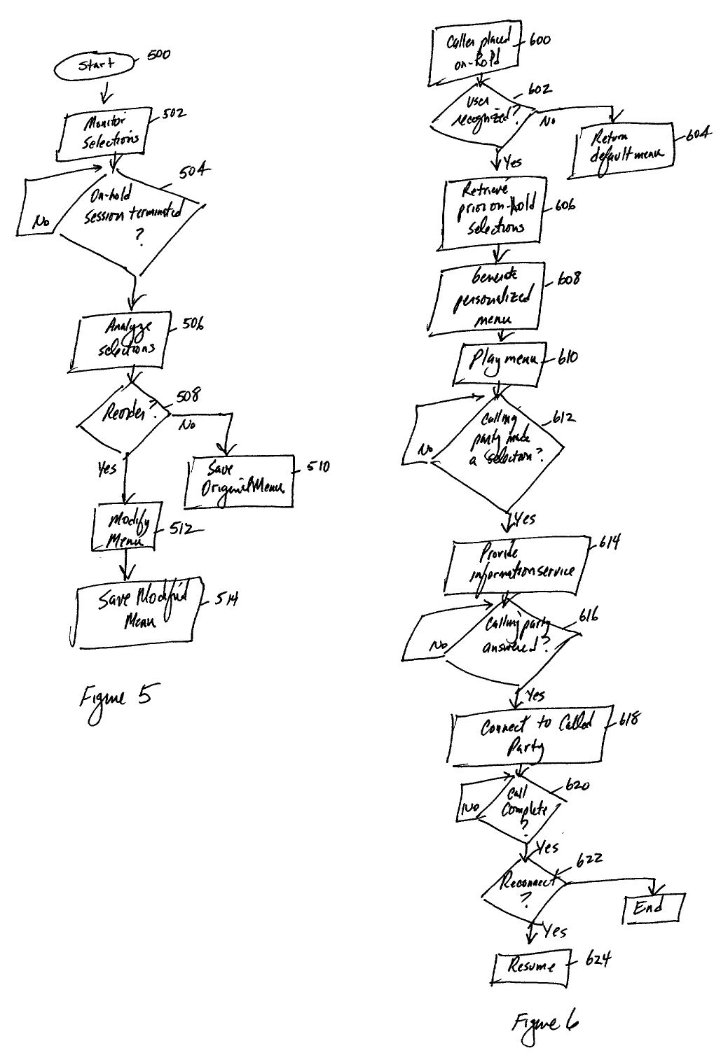

The above-described processing, wherein the information service optionally is resumed when the call is completed, may also be a default operation when the calling party is placed on-hold during the call. According to another technical advantage of the present invention, a user's personalized menu is modified from time-to-time as a result of interactivity with the menu. This functionality is illustrated in the flowchart of FIG. 5, which illustrates a menu adjustment routine. The routine preferably operates concurrently with the menu option selection routine described above with respect to FIG. 4. The menu adjustment routine begins at step 500 when the on-hold information system retrieves a user's personalized menu. At step 502, the routine monitors for a user's selection of a particular menu option. The routine then continues at step 504 to determine whether the particular on-hold session has been terminated (e.g., completely finished). If not, the routine cycles. If, however, the particular on-hold session has ended, the routine continues at step 506 to compare the user's selections during the session with prior selections that have been made from the menu. Any convenient correlation function may be used for this purpose. At step 508, a test is made to determine whether, as a result of the correlation, the user's personalized menu options should be reordered. If not, the routine branches to step 510 and saves the personalized menu unchanged. If, however, the result of the test at step 508 indicates that the menu should be modified, the routine continues at step 512 to modify the menu. Thus, for example, if the routine determines that a particular menu option (e.g., news about the stock market) is always selected by the user, the menu itself may be modified to list this option first when the menu is used in a future on-hold session. Of course, one of ordinary skill in the art will appreciate that the menu modifications will depend on the particular correlation function used by the routine as well as how often the user is placed on-hold. As more data is gathered, the menu choices may be conveniently altered to provide more relevant choices for the particular user. Preferably, more frequently selected items are prioritized over less frequently selected items. Returning now back to FIG. 5, after step 512, the modified menu is saved for future use at step 514. This completes the processing.

If desired, the personalized menu may be generated “on-the-fly” as the calling party is placed on-hold as a result of prior selections made by the user or other calling parties. FIG. 6 is a flowchart illustrating this technique, which presumes that a database of each calling party's prior on-hold menu selections (or some portion thereof) have been saved. The routine begins at step 600 when a particular calling party is placed on-hold. At step 602, a test is performed to determine whether the user has previously been on-hold. If not, the routine branches to step 604 and returns a default menu, optionally based on the user's originating telephone number. If, however, the user has previously been on-hold, the routine continues at step 606 to retrieve from the database the calling party's prior on-hold selections. From these selections, the routine continues at step 608 to generate a personalized menu for the user. This menu is then played to the calling party at step 610. At step 612, a test is performed to determine if the calling party has made a selection. If not, the routine cycles. Once a selection is made, the routine continues at step 614 to provide the information service. At step 616, a test is performed to determine whether the called party has answered. If not, the routine cycles. When the outcome of the test at step 616 indicates the called party has answered, the calling party is connected to the called party (e.g., a call handling agent). This is step 618. A test is then performed at step 620 to determine whether the call has been completed. If not, the routine cycles. If the outcome of the test at step 620 is positive, a test is performed at step 622 to determine if the calling party desires to continue with the information service. If the outcome of the test at step 622 is positive, the routine continues at step 624 to resume the information service, preferably at the point when the service offering was interrupted when the calling party was connected to the called party. If, however, the calling party does not wish to return to the information service, the routine terminates at step 626. This completes the processing.

To provide a calling party with the option of returning to the on-hold information service even after completing call, the on-hold information service preferably maintains status information indicating whether a particular calling party is on-hold or otherwise connected to the called party. Any convenient data structure (e.g., an array, a linked list, or the like) may be used for this purpose. When a call is received and the calling party is placed on-hold, the called party's PBX (or other switching system) sends an “on-hold” packet to the calling party's station set. When the called party answers the call, an “off-hold” packet is sent to the calling party station set. The calling party's station set uses these packets for synchronization.

In a call center environment, the on-hold information service will be handling a large number of calling parties. According to another feature of the present invention, it may be desirable to provide certain calling parties prioritized removal from call handling queues if such parties interact with certain menu options. In particular, a given calling party may be afforded faster access to a call handling agent if he or she selects a particular menu option (as compared to, for example, a calling party who does not have any personalized menu or who selects some other menu option). Alternatively, the on-hold information service may monitor the progress of a given on-hold session and retain the calling party connected to the information service (even if a call handling agent is then available) to ensure that given information is provided without interruption.

The on-hold information service provides numerous advantages over the prior art. With the present invention, a calling party is allowed to select options that are personally relevant to the caller when the caller is placed on-hold in a telephone system. By defining the personalized menu in advance, the caller knows that he or she will be provided with desirable information in the event of an on-hold situation. As described above, the caller can select from his or her own personalized active menu of options, which provide useful information, whenever the caller is placed on-hold. While on-hold during a telecommunications session, the caller can continue selecting useful menu options until the call is eventually answered, and he or she can elect to resume the on-hold information service even after the call is completed. The service provider saves the caller's prior selections in a profile that may then be used to determine which menu options are offered to the caller during subsequent on-hold sessions.

The inventive on-hold information service takes advantage of existing technology. Conventional IVR devices may be used to provide voiceover prompts. Conventional voice recognition systems and devices may be used to recognize control commands issued by a calling party. The inventive routines preferably comprise computer software routines that may be written in any convenient programming language (e.g., Java, C++, or the like) for any convenient hardware and operating system platform. As has been described, the inventive functionality may be provided as a standalone on-hold information service, or as an adjunct to an existing telephone switching system, PBX, PBX/ACD, or other information system, service, device or apparatus.

One of the preferred implementations of the invention is as a set of instructions (program code) in a code module resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Having thus described our invention, what we claim as new and desire to secure by Letters Patent is set forth in the following claims:

1. A method of using on-hold time during a telecommunications session, comprising:
responsive to detecting an on-hold status for a calling party, retrieving a menu of information options that has been defined by the calling party;
outputting the menu to the calling party; and responsive to selection of an information option, providing a selected information service to the calling party.

2. The method as described in claim 1 further including the step of saving the calling party's selection.

3. The method as described in claim 2 further including the step of modifying the menu of information options based on the calling party's selections over a given number of on-hold sessions.

4. The method as described in claim 1 further including the steps of:
interrupting the information service to connect the calling party to a called party; and
selectively resuming the information service upon completion of the call.

5. The method as described in claim 4 wherein the information service is resumed upon the calling party's request.

6. The method as described in claim 1 wherein the menu of information options is defined by having the user identify a set of desired information sources at a web server.

7. The method as described in claim 1 wherein the menu of information options is defined by having the user identify a set of desired information sources over a telephone.

8. The method as described in claim 1 further including the step of selectively connecting the calling party to a called party as a function of a given information source selected by the calling party.

9. The method as described in claim 1 further including the step of selectively delaying connection of the calling party to a called party until a given information source selected by the calling party is completed.

10. A method of using on-hold time during a telecommunications session, comprising:
having a user define a personalized menu of information options;
responsive to detecting an on-hold status for the user, retrieving the personalized menu of information options;
outputting the personalized menu to the user; and responsive to selection of a set of one or more information options, providing a set of one or more selected information services to the user.

11. The method as described in claim 10 further including the step of saving the user's information option selections.

12. The method as described in claim 11 further including the step of modifying the personalized menu of information options as a function of the user's selections.

13. The method as described in claim 12 wherein the modifying step reorders at least one information option in the personalized menu.

14. The method as described in claim 10 wherein the personalized menu of information options is defined by the user in an off-line process.

15. A computer program product in a computer useable medium for use in a computer to provide an onhold information service, comprising:
means for storing a personalized menu of information options for a user;
means responsive to detection of an on-hold status for the user for retrieving the personalized menu of information options;
means for outputting the personalized menu to the user; and
means responsive to selection of an information option from the personalized menu for connecting the user's telephone station set to a selected information source while the user waits to be connected to a called party.

16. The computer program product as described in claim 15 further including means for saving the user's information option selection.

17. The computer program product as described in claim 16 further including means for modifying the user's personalized menu of information options as a function of the user's information option selections over a plurality of on-hold sessions.

18. The computer program product as described in claim 15 wherein the station set is selected from a wireline telephone, a wireless telephone, and a computer configured with telephone software and Internet connectivity.

19. The computer program product as described in claim 15 further including means for selectively connecting the user's station set to a called party as a function of the selected information option.

20. The computer program product as described in claim 15 further including means for selectively delaying connection of the user's station set to a called party until output of a selected information option is completed.

21. An on-hold information service connectable to a switching system, comprising:
processor;
storage;
a computer program product executable by the processor, comprising:
code for storing in the storage a personalized menu of information options for a user;
code responsive to detection of an on-hold status for the user for retrieving from the storage the personalized menu of information options; code for outputting the personalized menu to the user; and code responsive to selection of an information option from the personalized menu for connecting the user's telephone station set to a selected information source while the user waits to be connected to a called party.

22. A method of using on-hold time during a telecommunications session, comprising:
responsive to detecting an on-hold status for a calling party, determining whether the calling party has been placed on-hold previously;
if the calling party has been placed on-hold previously, retrieving a set of one or more information options that were selected by the calling party while the calling party was on-hold previously;
outputting to the calling party a personalized menu including at least one information option selected by the calling party while the calling party was on-hold previously.

23. The method as described in claim 22 further including the step of prioritizing information options in the personalized menu as a function of selections made by the calling party while the calling party was on-hold previously.

24. The method as described in claim 22 further including the step of releasing the user from the on-hold status when a called party is available to answer the call.

25. A method of using on-hold time during a telecommunications session, comprising:
responsive to detecting an on-hold status for a calling party, determining whether the calling party has been placed on-hold during a prior call attempt;
if the calling party has been placed on-hold during a prior call attempt, outputting to the calling party a personalized menu including a set of one or more information options that were selected by the calling party while the calling party was on-hold during the prior call attempt;
releasing the user from the on-hold status upon a given occurrence.

26. The method as described in claim 25 wherein the given occurrence is that a called party is available to answer the call.

27. The method as described in claim 25 wherein the given occurrence is that an information service selected by the calling party has completed.

28. The method as described in claim 25 wherein the given occurrence is that the calling party has selected a given information option.
